(19) United States
(12) Patent Application Publication
(10) Pub. No.: US 2006/0044279 A1
(43) Pub. Date: Mar. 2, 2006

(54) Input device and mobile phone using the same

(76) Inventors: Tetsutaro Nasu, Ikoma-shi (JP); Koji Tanabe, Katano-shi (JP); Akito Kawasumi, Susono-shi (JP)

Correspondence Address: RATNERPRESTIA, P.O. BOX 980, VALLEY FORGE, PA, 19482, US

(21) Appl. No.: 11/210,335

(22) Filed: Aug. 24, 2005

(30) Foreign Application Priority Data
Aug. 27, 2004 (JP) 2004-248051

(51) Int. Cl. G09G 5/00

(52) U.S. Cl. 345/169

(57) ABSTRACT

An input device having a data entry section and a controller. The data entry section has a layered structure of “keyboard”-equipped printed input portion, EL device, and touch panel. The controller controls the EL device and the touch panel. Since the printed input portion has keyboard layout, users can input data with ease. Furthermore, the surface lighting of EL device can provide the input device with uniform lighting, increasing visibility of the entire device.

### 1. FIELD OF THE INVENTION

The present invention relates to an input device used for various kinds of electronic equipment, such as a mobile phone and a personal computer, and also relates to a mobile phone using the input device.

### 2. BACKGROUND ART

In recent years, advanced electronic equipment, such as a mobile phone and a personal computer equipped with high performance and multi functions, has been increasing. In such a trend, manufacturers have been seeking an input device capable of accepting various input style with simple operations, which is employed for the advanced equipments.

Here will be described a mobile phone equipped with a conventional input device with reference to FIG. 4.

The conventional mobile phone of FIG. 4 has fixed housing 1 and movable housing 7, both of which are made of insulating resin. Movable housing 7 is foldably attached to fixed housing 1. Fixed housing 1 contains, on the top surface, 3×4 vertically movable operation keys 3, which are used for entering data, such as a telephone number or a name. In a section adjacent to operation keys 3, sound input part 2 including a microphone is disposed.

Operation keys 3 are formed of an individual push button, such as button 3A, button 3B. Each button bears a number and letters of the alphabet and kana i.e., Japanese syllabic writing (not shown). For example, button 3A bears “1” of a numeric character, letter “a” of the Romaji (the Roman alphabet), and “ABC” of the alphabet; button 3B bears “2” of a numeric character, letter “ka” of the Romaji, and “DEF” of the alphabet.

In a section behind operation keys 3 on the surface of fixed housing 1, vertically movable function keys 4, and tilt button 5 that can be tilted upward, downward, toward right, and left.

On the other hand, on the surface of insulating resin-made movable housing 7, display 8 including a liquid crystal display device and sound output part 9 including a loudspeaker are disposed.

Next will be described how to use the conventional mobile phone having the structure above. When entering numerical data in placing a call, an operator enters a receiver's phone number by pushing a proper button among operation keys 3. After a series of numbers corresponding to the key-input is shown on display 8, the operator pushes a predetermined transmission key to establish telephone communications through radio waves.

On the other hand, when entering character data, such as a name and e-mail text, the operator pushes a predetermined key among function key 4 to select a character-input mode, and may select the alphanumeric-input mode. Then, he pushes button 3A once and “A” is displayed on display 8, and may push the same button again and “B” will be displayed on display 8. After that, pushing a confirmation key, with a desired letter, for example, “A” of the alphabet shown on the screen, determines the letter as confirmed data. Subsequently, in the same alphanumeric-input mode, pushing button 3B twice shows “E” on the screen. Like the confirmation operation for “A”, pushing the confirmation key with letter “E” on the screen determines “E” as a confirmed letter. Through the above operation, “AE” appears on display 8. In this way, the operator enters a name or e-mail text by repeating the operation of operation keys 3.

Besides, a push on the upper, lower, right, or left brim of tilt button 5 tilts the button in respective directions, which moves the cursor in a direction of the tilt for selecting a desired menu from a menu list. Furthermore, a light-emitting device (not shown) including a light-emitting diode is disposed in fixed housing 1. When the mobile phone receives an incoming call or e-mail, or accepts input operations through function keys 4, the light-emitting device emits light from the backside of input device 6.

As an input device structured above, Japanese Patent Unexamined Publication No. 2003-36768 introduces an operation knob that provides tilt operations.

However, to cope with complex input operations of a multi-functioned device with the use of the aforementioned conventional input device, it becomes necessary to increase the number of operation keys 3 and function keys 4 of input device 6; if not, requires to assign multi functions to a single key and therefore the operator has to go through complicatedly combined operations to select a desired function. Such a structure increases parts number and complexity in key operations. It has been another problem that a large number of light-emitting devices are required for uniformly lighting up input device 6.

### SUMMARY OF THE INVENTION

It is therefore the object of the present invention to provide an input device that offers an easy input operation and uniform lighting over the data entry section.

To achieve the object above, the input device of the present invention has a data entry section formed of a printed input portion having a “keyboard”; an electroluminescent (EL) device for illuminating the printed input portion; and a touch panel having a usable area at least, in size, equivalent to the printed input portion. By pressing a key of the printed input portion, the operator can carry out data entry with no complicated operations. At the same time, surface lighting of the EL device uniformly lights up the entire area of the input device.

The mobile phone of the present invention has a data entry section fixed to the housing of the phone and a controller connected to the data entry section. The data entry section further contains a printed input portion where the operator can input data through a “keyboard”; an electroluminescent (EL) device for illuminating the printed input portion; and a touch panel having a usable area equivalent to or greater, in size, than the printed input portion. The controller controls lighting of the EL device and detects a pushed position on the touch panel. Having a simple structure above, the mobile phone can offer an operator a variety of input operations and uniform lighting over the data entry section.

Additional objects and advantages of the present invention will be apparent from the following detailed description of preferred embodiments thereof, which are best understood with reference to the accompanying drawings.

### BRIEF DESCRIPTION OF THE DRAWINGS

FIG. 1 is a sectional view of an input device of an embodiment of the present invention.

FIG. 2 schematically shows the structure of an input device of an embodiment of the present invention.

FIG. 3 is a perspective view of a mobile phone on which the input device of the embodiment is mounted.

FIG. 4 is a perspective view of a conventional mobile phone.

### DETAILED DESCRIPTION OF THE INVENTION

The input device of the present invention has a “keyboard”-equipped printed input portion; an electroluminescent (EL) device for lighting the printed input portion; and a touch panel with a usable area equivalent to or greater, in size, than the printed input portion. The touch panel is so formed that an upper electrode disposed on a top substrate faces a lower electrode disposed on a bottom substrate at a predetermined spaced interval.

As an advantage of the input device of the present invention, data entry with the use of the printed input portion having a keyboard layout allows the operator to carry out multi-functional operations with ease. Besides, by virtue of the EL device, the uniformly illuminated printed input portion can provide the operator with an increased visibility.

As another advantage of the input device, the EL device contains a plurality of light-emitting layers, which emits a light in different colors. The printed keys disposed in the printed input portion can be easily distinguished by the different light color. This reduces errors in key-input; accordingly, increases the efficiency of input operations.

As still another advantage of the input device, the data entry section may be formed on a light transmitting substrate of the EL device. The structure eliminates the need for a display sheet, reducing parts number, and therefore reducing production costs.

As yet another advantage, the input device may have a structure in which an upper electrode and a lower electrode of the touch panel are connected to a controller. When push operations are applied to the printed input portion, the upper electrode makes contact with the lower electrode, and upon the contact, the controller detects the contact position. Such structured input system offers the operator easy operations and uniform lighting over the data entry section.

As still another advantage of the input device, the controller can control the light-on/off of the EL device in response to the push operations applied to the data entry section. For example, to conserve power, the controller turns off the EL device after an interval during which no printed key has been pressed. Further, the controller controls the EL device to have various lighting patterns, such as flushing, according to predetermined input operations.

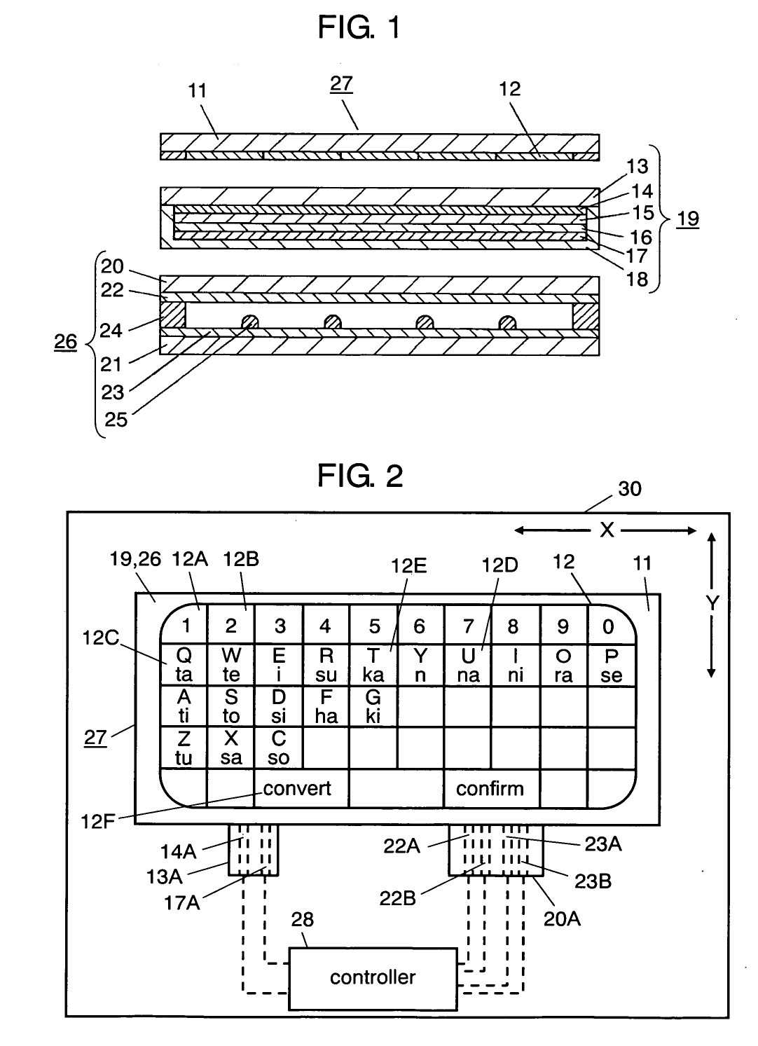

An embodiment of the present invention is described hereinafter with reference to the accompanying drawings, FIG. 1 through FIG. 3. In the description, elements similar to those described in Background Art have the same reference marks, and the descriptions of those elements are omitted.

### Embodiment

FIG. 1 is a sectional view of data entry section 27 of an input device of an embodiment of the present invention. FIG. 2 schematically shows the structure of input device 30 of the embodiment. As shown in those drawings, data entry section 27 of the embodiment contains light transmitting display sheet 11, EL device 19, and touch panel 26. It will be understood that FIG. 2 shows the keyboard of input device 30 with keys necessary for description of the embodiment.

As a novelty of the present invention, data entry section 27 has a keyboard layout. To provide the function, printed input portion 12, which bears numeric characters, kana (Japanese syllabic writing) in the JIS layout, and alphabets in the QWERTY layout, is disposed under display sheet 11. Printed input portion 12 contains a plurality of printed keys, such as 12A, 12B, and 12C. Display sheet 11 is a transparent film made of polyethylene terephthalate, polycarbonate, or the like. In this embodiment, kana (Japanese syllabic writing) is explained using Romaji (the Roman alphabet) for easy understanding.

EL device 19 is disposed under display sheet 11. EL device 19 contains a transparent base film 13 at the top surface. Under base film 13, light transmitting electrode layer 14 is formed. Electrode layer 14 is so formed that light transmitting synthetic resin—a phenoxy- and an epoxy-resin in which conductive fine particles of indium tin oxide are closely dispersed—is printed thereon.

Under light transmitting electrode layer 14, light-emitting layer 15, dielectric layer 16, and rear electrode layer 17 are disposed in upper-to-lower order. Light-emitting layer 15 is made of a synthetic resin, such as zinc sulfide-dispersed fluorine rubber. Dielectric layer 16 is made of a synthetic resin, such as barium titanate dispersed fluorine rubber. Rear electrode layer 17 is made of a synthetic resin in which silver or carbon is dispersed. The stack of each layer is then entirely covered with insulating layer 18 made of epoxy- or polyester-resin to complete EL device 19.

Touch panel 26 is disposed under EL device 19. Touch panel 26 is so formed that top substrate 20 and bottom substrate 21, both of which are a transparent film, are opposed each other via frame-like spacer 24 that runs along the peripheries of the substrates. Top substrate 20 is made of polyethylene terephthalate, polycarbonate, or the like, while bottom substrate 21 is made of glass, acrylic resin, or the like.

With the use of materials including indium tin oxide, tin oxide, and carbon, upper electrode 22 is formed under top substrate 20, and lower electrode 23 is formed over bottom substrate 21 by spattering or printing.

Dot spacers 25 made of synthetic resin, such as an epoxy resin and a silicon resin, are formed on lower electrode 23 at predetermined spaced intervals, so that upper electrode 22 faces lower electrode 23, maintaining a predetermined interval. Touch panel 26 is thus completed. Such formed touch panel 26 should preferably contain a usable area equivalent to, or greater than the outside shape of printed input portion 12 having a keyboard-layout printed on display sheet 11. The usable area mentioned above is the confronting area of upper electrode 22 and lower electrode 23 of touch panel 26, where a position at which a pushing force is applied is accurately detectable.

Data entry section 27 is a stacked structure of touch panel 26, EL device 19, and display sheet 11.

Here will be described data entry section 27 that further includes a controller with reference to FIG. 2. For convenience's sake, the input device including a controller is herein referred to input device 30.

Wiring pattern 14A, which is connected to light transmitting electrode layer 14 of EL device 19, and wiring pattern 17A connected to rear electrode layer 17 are extended to tail portion 13A that projects outwardly from base substrate 13.

On touch panel 26, a pair of wiring patterns 22A, 22B are disposed at the front and rear ends of upper electrode 22 of touch panel 26 (in the directions of arrows Y in FIG. 2); similarly, a pair of wiring patterns 23A, 23B are disposed at the right and left ends of lower electrode 23 (in the directions of arrows X in FIG. 2) so as to be orthogonal to wiring patterns 22A and 22B. Wiring patterns 22A, 22B, 23A, and 23B are routed through tail portion 20A of top substrate 20.

Wiring patterns 14A,17A of EL device 19 and wiring patterns 22A, 22B, 23A, 23B are connected to controller 28 formed of a microprocessor, an IC chip, or CPU. Input device 30 is thus completed. When an operator pushes a position in touch panel 26, controller 28 detects where the pushed position is located in keyboard-arranged display sheet 11 (for example, printed keys 12A, 12B) and determines the data entered by the operator.

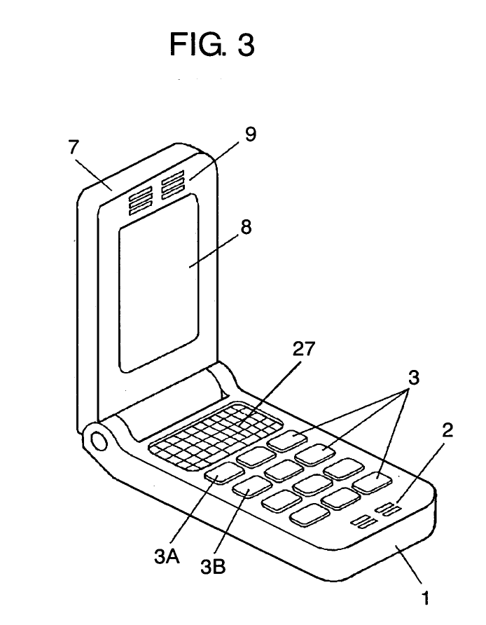

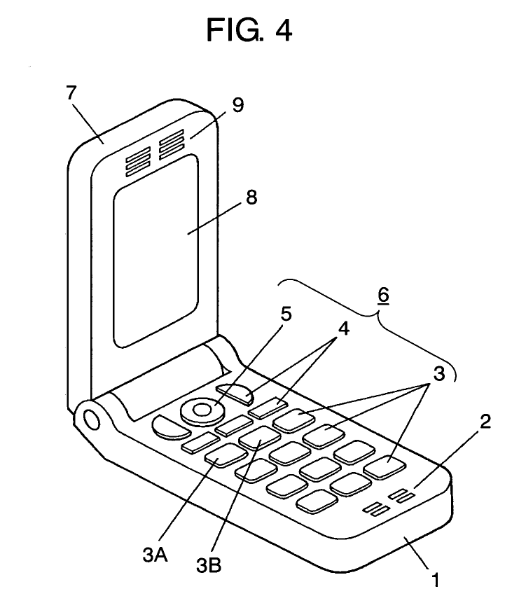

Now will be described the workings of data entry section 27 and input device 30 when the structure is employed for a mobile phone, with reference to FIG. 3.

FIG. 3 is a perspective view of a mobile phone having the input device of the present invention therein. Insulating resin-made fixed housing 1 has, on its top surface, sound input part 2 including a microphone, and a plurality of vertically movable operation keys 3 used for entering data, such as a telephone number and a name. Data entry section 27 is disposed behind operation keys 3. Operation keys 3 include keys 3A, 3b and the like.

On the other hand, insulating resin-made movable housing 7 has, on its surface, display 8 formed of, for example, liquid crystal display devices, and sound output part 9 including a loudspeaker. Movable housing 7 is foldably attached to fixed housing 1 in the mobile phone of the embodiment.

Here will be described how to operate the mobile phone. Description is given on operations of entering and displaying numeric characters of, for example, “12” on display 8. First, push button 3A that bears a numeric character of “1”, and then push button 3B that bears “2”. In addition to the conventionally used operations, the operator can get the same result by pushing printed key 12A and then key 12B of the keyboard, as shown in FIG. 2, in a predetermined input mode. That is, to input a receiver's telephone number and display it in display 8, the operator can use operation keys 3 or printed input portion 12. After that, the operator pushes a predetermined transmission key to communicate with the receiver. As for the transmission key, the transmitting function can be assigned to one of operation keys 3 or to a key of the keyboard of printed input portion 12.

Next will be described operations on entering and displaying letters, such as a name and e-mail text. In this case, after operating a predetermined button of operation keys 3, the operator pushes, for example, key 12C of printed input portion 12 with the tip of a finger or a pen. With the application of pushing force, the pushed position on display sheet 11 bends down. The force further bends top substrate 20 of touch panel 26 through EL device 19, thereby making contact upper electrode 22 disposed under the pushed position with lower electrode 23 disposed on bottom substrate 21. In response to the contact, controller 28 applies voltage, through wiring patterns 22A and 22B, to upper electrode 22 in the directions indicated by arrows Y of FIG. 2 to locate the position at which upper electrode 22 contacts with lower electrode 23 in the Y directions. Next, controller 28 applies voltage, through wiring patterns 23A and 23B, to lower electrode 23 in the directions indicated by arrows X of FIG. 2 to locate the position at which upper electrode 22 contacts with lower electrode 23 in the X directions. Through the process above, controller 28 defines the exact position on touch panel 26 and relates the position to a corresponding key in printed input portion 12. In this way, controller 28 detects that the operator pushed key 12C.

In the wake of detecting the exact position in the directions of arrows X and Y, in the kana-input mode, “ta” in Romaji appears on display 8, or in alphanumeric-input mode, “Q” of the alphabet appears. When the operator pushes key 12D and then key 12E, in the kana-input mode, “na” and then “ka” in Romaji follows “ta”, so that “ta-na-ka” in Romaji is shown on the display, or in the alphanumeric-input mode, “QUT” appears.

When the operator pushes key 12F, which is the conversion key, the keystrokes of “ta-na-ka” in Romaji is converted, through Kana-Kanji conversion, into corresponding Kanji characters having the reading “ta-na-ka”.

A typing-style input of the present invention, as described above, frees the operator from complicated operations in which a button has to be pushed several times until a desired letter is obtained. With the use of printed input portion 12 having a=JIS-layout for kana, and a QWERTY-layout for alphabet, just the same as a familiar keyboard of a personal computer and a word processor, the operator can enter letters in kana or alphabet used for a name or e-mail text in quick and easy way.

At the same time, controller 28 applies voltage, through wiring patterns 14A and 17A, to light transmitting electrode layer 14 and rear electrode layer 17 of EL device 19. The application of voltage causes surface lighting of light-emitting layer 15, which illuminates, with different colors in parts, the entire area of display sheet 11. Therefore, even in the dark, a great visibility of printed input portion 12 can be obtained. Furthermore, by virtue of the uniform lighting over printed input portion 12, the operator can recognize the individual key of the keyboard without variations in brightness.

The input device of the present invention has a layered structure having touch panel 26, EL device 19, and display sheet 11 stacked in lower-to-higher order. Besides, data entry section 27 of the input device is formed of printed input portion 12 in a JIS-, and QWERTY-layout. Since the keyboard layout of printed input portion 12 is the same as that of an ordinary keyboard, the operator can input data with ease. Besides, the surface lighting of EL device 19 can provide the input device with uniform lighting, increasing visibility of the entire device.

Compared to the structure having an actual keyboard formed of several rows of push buttons, the printed input portion-equipped input device of the present invention can reduce the area required for the keyboard. That is, in a limited area, the printed input portion of the invention can contain more keys for carrying out multi function than the actual keyboard-equipped device, realizing multi-functioned data entry. In other words, when the keyboard of the present invention is formed similar to a button-equipped keyboard in terms of the number of keys and layout, mobile equipment employing the printed input portion can be more compact.

Furthermore, EL device 19 can contain a plurality of light-emitting layers 15 with different colors. For example, the printed keys that bear numeric only, such as keys 12A, 12B disposed in the first row, may be illuminated in orange; the rest, such as keys 12C, 12D, may be illuminated in green. Lighting over printed input portion 12 with different colors in parts can offer operators an easy-to-see layout and nimble operation with minimized mistakes.

Although EL device 19 is sandwiched between display sheet 11 and touch panel 26 in the structure of the embodiment, it is not limited thereto; EL device 19 can be disposed under touch panel 26. In this case, all the components forming touch panel 26—top substrate 20, upper electrode 22, lower electrode 23, and bottom substrate 21—should be light transmitting. Light transmitting upper electrode 22 and lower electrode 23 should preferably be made of indium tin oxide or tin oxide with optical transparency.

Although printed input portion 12 is formed under display sheet 11 in the description, it is not limited thereto; forming printed input portion 12 over display sheet 11 can provide the same effect. Further, another possibility is a structure in which printed input portion 12 is formed directly on or beneath base substrate 13. In this case, there is no need to use display sheet 11, which contributes to a cost-reduced device with a low parts number.

A novelty in data entry section 27 of the present invention is in the use of printed input portion 12 easily recognizable from an operator, particularly, in the printed input portion 12 having a keyboard layout.

Using EL device in the present invention can provide various lighting patterns over printed input portion 12. In response to the push force applied to printed input portion 12 via the touch panel, controller 28 can control the light-on/off of EL device 19. For example, to conserve power, the controller turns off EL device 19 after an interval during which no operation has been carried out. Further, the controller controls EL device 19 to have various lighting patterns, such as flushing for incoming call, according to predetermined input operations.

The input device and a mobile phone using the device of the present invention, as described above, provides users with easy input operations and uniform lighting over the data entry section. The input device of the invention is also applicable to personal computers and other electronic equipment that require multi-functioned input, as well as mobile phones.

It will be obvious to those skilled in the art that various changes may be made in the above-described embodiment of the present invention. However, the scope on the present invention should be determined by the following claims.

What is claimed is:

1. An input device comprising:
a data entry section including:
a printed input portion having a keyboard layout;
an electroluminescent (EL) device for lighting up the printed input portion; and
a touch panel having a structure in which an upper electrode disposed on a top substrate confronts a lower electrode disposed on a bottom substrate at a predetermined spaced interval, and having a usable area sized to be equivalent to, or greater than the printed input portion.

2. The input device of claim 1, wherein the EL device has a layered structure in which a light transmitting base substrate, a light transmitting electrode layer, a light-emitting layer, and rear electrode layer are disposed in a top-to-bottom order, and the touch panel is disposed under the EL device.

3. The input device of claim 2, wherein the printed input portion is formed on one of surfaces of the light transmitting base substrate of the EL device.

4. The input device of claim 1, wherein a transparent film is disposed on the EL device, the printed input portion is formed on one of surfaces of the transparent film, and the touch panels is disposed under the EL device.

5. The input device of claim 1, wherein the EL device contains a plurality of light-emitting layers each of which emits different color, whereby the printed input portion is illuminated with different colors.

6. The input device of claim 1, wherein the EL device is disposed under the touch panel, all components of the touch panel—the top substrate; the upper electrode; the lower electrode; and the bottom substrate—are light transmitting, the EL device illuminates the printed input portion through the touch panel.

7. The input device of claim 1, wherein the EL device is disposed under the touch panel, all components of the touch panel—the top substrate; the upper electrode; the lower electrode; and the bottom substrate—are light transmitting, a transparent film is disposed on the touch panel, the printed input portion is formed on one of surfaces of the transparent film, and the EL device illuminates the printed input portion through the touch panel.

8. The input device of claim 1 further includes a controller connected to the EL device and the touch panel, wherein the controller detects a pushed position in the touch panel and then relates the position to a corresponding key position of the printed input portion.

9. The input device of claim 8, wherein the controller detects pushing operations applied to the touch panel and turns on or off the EL device according to the pushing operations.

10. A mobile phone comprising:
a data entry section fixed to a housing of the mobile phone, the data entry section further including:
a printed input portion having a keyboard layout;
an EL device for illuminating the printed input portion; and
a touch panel having a structure in which an upper electrode disposed on a top substrate confronts a lower electrode disposed on a bottom substrate at a predetermined spaced interval, and having a usable area sized to be equivalent to, or greater than the printed input portion; and
a controller connected to at least the data entry section, which is responsible for lighting control of the EL device and for detecting a pushed position in the touch panel.

11. The mobile phone of claim 10, wherein the controller detects pushing operations applied to the touch panel and turns on or off the EL device according to the pushing operations.
